(19) United States
(12) Patent Application Publication
(10) Pub. No.: US 2024/0123885 A1
(43) Pub. Date: Apr. 18, 2024

(54) TABLE SYSTEM FOR MEANS OF TRANSPORT

(71) Applicant: LCI ITALY S.R.L., Florence (IT)

(72) Inventors: Francesco TATINI, FIorence (IT); Francesco CAVINI, Florence (IT)

(21) Appl. No.: 18/488,187

(22) Filed: Oct. 17, 2023

(30) Foreign Application Priority Data
Oct. 17, 2022 (IT) 202022000004200

(51) Int. Cl. B60N 3/00

(52) U.S. Cl. CPC B60N 3/001

(57) ABSTRACT

A table system for means of transport includes a supporting surface, and a frame for supporting the supporting surface. The supporting surface has a tubular element and a sheet stably connected and at least partly superposed. First connecting structure is designed to stably connect the frame to the wall.

### CROSS-REFERENCES TO RELATED APPLICATIONS

This application claims priority of Italian Utility Model Application No. 202022000004200 filed Oct. 17, 2022, the entire content of which is hereby incorporated by reference in this application.

### BACKGROUND

This invention relates to a table system for means of transport.

In particular, the invention relates to a table system which can be advantageously applied in a railway carriage.

Many means of transport, such as for example railway carriages or buses, currently have tables between the passenger seats designed to support small objects, such as mobile phones, tablets and portable computers, but also drinks, books, magazines or the like.

A quite widespread seating configuration is that of having four seats in opposite pairs, that is to say, two facing the direction of travel and the other two facing in the opposite direction, with a table between them designed to support the above-mentioned items.

Other configurations include tables, with a more limited size, facing only two passengers.

According to prior art solutions there are tables having a supporting surface supported by a relative leg fixed on the floor and, if necessary, a further supporting bracket connected to a wall.

The above-mentioned leg and, where present, the wall-mounted bracket, are designed to guarantee a stable support for the supporting surface of the table, which performs structural functions.

This circumstance, that is to say, the fact that the supporting surface is also required to carry out main structural functions, relative to the retaining of the table in its entirety, means that the constraints imposed on designers in the design of new interior furnishings for railway carriages or means of transport in general are high.

In other words, since the supporting surface of the table has to guarantee predetermined levels of mechanical performance and structural strength, these constraints often constitute exceptional limitations which are difficult to overcome by the designers.

### SUMMARY

The aim of the invention is to provide a table system which is able to overcome the drawbacks of the prior art and which is at the same time practical to install and simple and inexpensive to make.

A further aim of the invention is to provide a table system for means of transport which offers great versatility and allows the adoption of many supporting surfaces.

Another aim of the invention is to provide a table system which can guarantee that the loads applied are held stably avoiding unwanted bending of the supporting surface, and which at the same time has a reduced size. According to the invention, these aims and others are achieved by a table system for means of transport comprising the technical features described in the accompanying claims.

### BRIEF DESCRIPTION OF THE DRAWINGS

The technical features of the invention, with reference to the above-mentioned aims, are clearly described in the appended claims and its advantages are apparent from the detailed description which follows, with reference to the accompanying drawings which illustrate non-limiting example embodiments of the invention, in which:

FIG. 1 shows a schematic perspective view from above of a table system for means of transport according to the invention,

FIG. 2 shows a schematic perspective view from above of the frame of the system of FIG. 1,

FIG. 3 shows a schematic perspective view from below of the frame of FIG. 2,

FIG. 4 shows a schematic front view of the frame of FIG. 2,

FIG. 5 shows a schematic view from below of the frame of FIG. 2,

FIG. 6 shows a schematic view from above of the frame of FIG. 2 and

FIG. 7 shows a schematic side view of the frame of FIG. 2.

### DETAILED DESCRIPTION

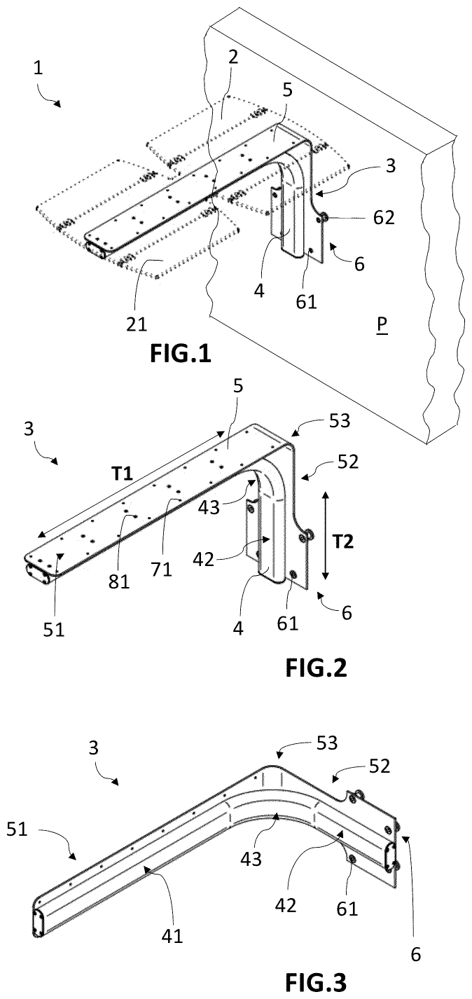

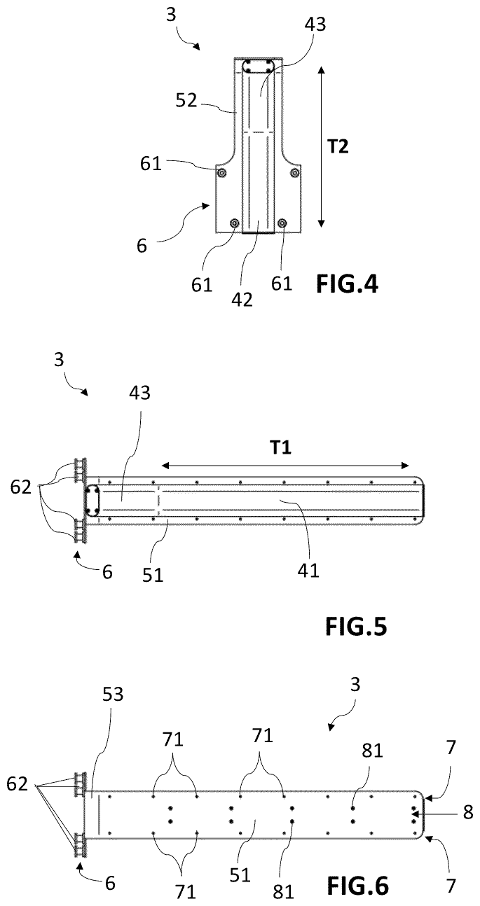

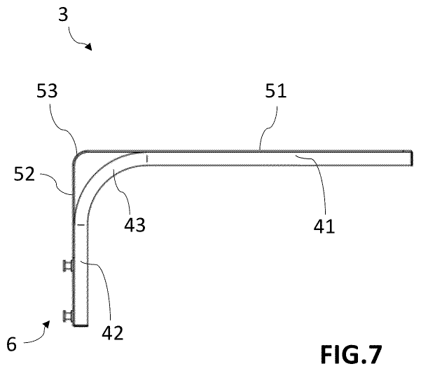

With reference to FIG. 1, the numeral 1 denotes in its entirety a table system for means of transport, not illustrated, hereinafter also referred to simply as system 1.

The system 1 comprises a supporting surface 2.

More in detail, the supporting surface is of the type used for resting food, beverages or any object such as books or electronic devices.

Advantageously, the supporting surface 2 comprises a plurality of separate elements.

According to a further embodiment, the supporting surface 2 is made in a single body.

Advantageously, also, with reference to FIG. 1, the supporting surface 2 comprises openable elements 21. The openable elements 21 allow the overall dimensions of the supporting surface 2 to be limited when the system 1 is not in use and optimise its convenience when, on the other hand, it is in use.

With reference to the accompanying drawings, the system 1 according to the invention also comprises a frame 3 supporting the supporting surface 2.

The supporting frame 3 comprises a tubular element 4 and a sheet 5 connected stably and at least partly superposed.

The frame 3 is designed to be stably connected to a wall P of the means of transport.

The tubular element 4 has a longitudinal portion 41 extending substantially parallel to the supporting surface 2.

The tubular element 4 also has a transversal portion 42 with an extension substantially parallel to a wall P of the means of transport.

Advantageously, the transversal portion 42 is substantially perpendicular to the longitudinal portion 41.

The tubular element 4 also comprises a curved portion 43, interposed between the longitudinal portion 41 and the transversal portion 42.

The sheet 5 has a longitudinal portion 51 with an extension substantially parallel to the supporting surface 2.

The longitudinal portion 51 of the sheet 5 is stably connected to the longitudinal portion 41 of the tubular element 4.

The sheet 5 also has a transversal portion 52 extending substantially parallel to the wall P.

The transversal portion 52 of the sheet 5 is stably connected to the transversal portion 42 of the tubular element 4.

The sheet 5 also comprises a curved portion 53, interposed between the longitudinal portion 51 and the transversal portion 52 of the sheet 5.

Advantageously, the curved portion 53 of the sheet 5 is positioned spaced from the curved portion 43 of the tubular element 4.

Advantageously, the curved portion 43 of the tubular element 4 has a curvature greater than the curved portion 53 of the sheet 5.

In detail, the difference in curvature between the curved portion 43 of the tubular element 4 and the curved portion 53 of the sheet 5 generates a gap between the tubular element 4 and the sheet 5.

Advantageously, the curved portion 43 of the tubular element 4 has a curvature of between 180 and 220 sexagesimal degrees.

Still more advantageously, the curved portion 43 of the tubular element 4 has a curvature of approximately 200 sexagesimal degrees.

Advantageously, moreover, the curved portion 53 of the sheet 5 has a curvature of between 70 and 110 sexagesimal degrees.

Further, still more advantageously, the curved portion 53 of the sheet 5 has a curvature of approximately 90 sexagesimal degrees.

Advantageously, the tubular element 4 is made from a metal profile and the curved portion 43 of the tubular element 4 is made by plastic deformation of the metal profile.

Technical ducts designed for the passage of wiring are defined inside the tubular element 4.

In particular, these technical ducts are used, for example, to favour the installation of electrical power sockets for recharging electronic devices.

In fact, the system 1 advantageously comprises at least one electrical recharging socket positioned on the tubular element 4.

Moreover, advantageously, the tubular element 4 is made of aluminium.

The sheet 5 is advantageously made of a metallic material and the respective curved portion 53 is made by plastic deformation.

Moreover, advantageously, the metal profile of the sheet is made of an aluminium alloy.

According to further embodiments, the sheet 5 is made of plastic material and the respective curved portion 53 is made by plastic deformation of the plastic material.

The sheet 5 is interposed at least for a first stretch T1 between the tubular element 4 and the supporting surface 2, and for at least a second stretch T2 between the tubular element and the wall P of the means of transport.

Advantageously, the sheet 5 has ribs to increase the mechanical strength of the frame 3.

The system 1 according to the invention comprises first connecting means 6 positioned on the transversal portion 52 of the sheet 5 and designed to stably connect the frame 3 to the wall P.

The connecting means 6 also allow the forces acting on the supporting surface 2 to be discharged onto the wall P, avoiding unwanted bending of the supporting surface 2.

Advantageously, the first connecting means 6 comprise threaded means.

The first connecting means 6 also comprise a plurality of spacer elements 62 positioned between the portion 52 of the sheet 5 and the wall P.

The spacer elements 62 are positioned between the transversal portion 52 of the sheet 5 and the wall P. Advantageously, the spacer elements 62 have a variable length in such a way that they can be adapted to various curvatures of the wall P.

The system 1 comprises second connecting means 7 for stably connecting the frame 3 with the supporting surface 2.

The second connecting means 7 are made on the sheet 5 and on the supporting surface 2 along the first stretch T1.

Advantageously, the second connecting means 7 comprise threaded means 71.

The system 1 also comprises third connecting means 8 for stably connecting the tubular element 4 with the sheet 5.

The third connecting means 8 are made on the tubular element 4 and on the sheet 5 along the first stretch T1 and along the second stretch T2.

Advantageously, the third connecting means 8 comprise threaded means 81.

According to further embodiments, the third connecting means 8 connect the tubular element 4 and the sheet 5 by means of structural glues.

According to further embodiments, the tubular element 4 and the sheet 5 are connected stably by welding.

Advantageously, the system 1 according to the invention comprises, fixed below the tubular element 4, guards for housing objects, made in the form of a drawer. The table system according to the invention achieves the preset aims and brings important advantages.

A first advantage of the table system according to the invention is due to the fact that it provides a system which is simple to make and efficient to operate. Another advantage of the invention is due to the fact that it provides a table system which is able to optimise the overall dimensions thanks to the absence of legs which can sometimes be annoying for a user.

Another advantage of the invention is that it provides a table system which is held stably in the presence of loads whilst being characterised by a simple structure and with a low overall size.

1. A table system for means of transport, comprising:
a supporting surface;
a frame supporting said supporting surface, comprising a tubular element and a sheet stably connected and at least partly superposed, said frame being designed to be stably connected to a wall of said means of transport, said tubular element having:
a longitudinal portion extending substantially parallel to said supporting surface,
a transversal portion extending substantially parallel to said wall,
a curved portion, stably interposed between said longitudinal portion and said transversal portion, said sheet having:
a longitudinal portion extending substantially parallel to said supporting surface and stably connected to said longitudinal portion of said tubular element,
a transversal portion extending substantially parallel to said wall and stably connected to said transversal portion of said tubular element,
a curved portion, interposed between said longitudinal portion and said transversal portion of said sheet,
said sheet being interposed at least for a first stretch between said tubular element and said supporting surface and for at least a second stretch between said tubular element and said wall;
said sheet also comprising first connecting means positioned on said transversal portion and designed to stably connect said frame to said wall.

2. The system according to claim 1, wherein said curved portion of said tubular element has a curvature which is greater than said curved portion of said sheet.

3. The system according to claim 1, wherein said curved portion of said tubular element has a curvature of between 180 and 220 sexagesimal degrees.

4. The system according to claim 1, wherein said curved portion has a curvature of approximately 200 sexagesimal degrees.

5. The system according to claim 1, wherein said curved portion of said sheet has a curvature of between 70 and 110 sexagesimal degrees.

6. The system according to claim 1, wherein said curved portion of said sheet has a curvature of approximately 90 sexagesimal degrees.

7. The system according to claim 1, wherein said tubular element comprises a metal profile and said respective curved portion is made by plastic deformation of said metal profile.

8. The system according to claim 1, wherein said sheet is made of a metallic material and said respective curved portion is made by plastic deformation.

9. The system according to claim 1, wherein said sheet is made of plastic material and said respective curved portion is made by plastic deformation of said plastic material.

10. The system according to claim 1, comprising second connecting means for stably connecting said frame with said supporting surface, said second connecting means being formed on said sheet and on said supporting surface along said stretch.

11. The system according to claim 1, comprising third connecting means for stably connecting said tubular element with said sheet, said third connecting means being made on said tubular element and on said sheet along said first stretch and said second stretch.

12. The system according to claim 1, wherein said first connecting means comprise threaded means.

13. The system according to claim 1, wherein said first connecting means comprise a plurality of spacer elements positioned between said portion of said sheet and said wall.

14. The system according to claim 10, wherein said second connecting means comprise threaded means.

15. The system according to claim 11, wherein said third connecting means comprise threaded means.

16. The system according to claim 1, wherein inside said tubular element there are technical ducts designed for the passage of wiring.

17. The system according to claim 1, wherein said tubular element is made of aluminium.

18. The system according to claim 1, wherein said sheet is made of aluminium.

19. The system according to claim 1, wherein said supporting surface is made as a single body.

20. The system according to claim 1, wherein said supporting surface comprises a plurality of separate elements.
